(19) United States
(12) Patent Application Publication
(10) Pub. No.: US 2025/0344090 A1
(43) Pub. Date: Nov. 6, 2025

(54) RI/CQI PREDICTION FOR MULTIPLE PREDICTED CSI

(71) Applicant: InterDigital Patent Holdings, Inc., Wilmington, DE (US)

(72) Inventors: Ahmet Serdar Tan, London (GB); Patrick Tooher, Montreal (CA); Moon IL Lee, Melville, NY (US); Mihaela Beluri, Jericho, NY (US)

(73) Assignee: InterDigital Patent Holdings, Inc., Wilmington, DE (US)

(21) Appl. No.: 18/656,128

(22) Filed: May 6, 2024

(51) Int. Cl. H04W 24/10; H04L 41/16

(52) U.S. Cl. CPC H04W 24/10; H04L 41/16

(57) ABSTRACT

A method implemented by a wireless transmit receive unit (WTRU) may include receiving configuration information from a network, and receiving network assistance information for CSI prediction from the network. The method may include determining historical channel measurements based on a plurality of measurement resources, such as historical quality-based metrics based on Interference Measurement Resources (IMRs) and historical CSI measurements based on channel measurement resources. The method may include determining a CSI prediction value for a future CSI prediction instance based on the historical channel measurements, such as the historical CSI measurements. The method may include determining a quality-based metric for the future CSI prediction instance based on the historical channel measurements, such as the historical quality-based metrics and the network assistance information. The method may include sending an indication of the quality-based metric for the future CSI prediction instance to the network.

### BACKGROUND

A WTRU may perform multiple Channel State Information (CSI) prediction(s), receive reference IMR set(s), receive assistance information (e.g., historical time instances associated with reference IMR sets) from the network (NW), and then may compute estimated interference and predict quality-based metrics (e.g., Rank Indicator (RI), Channel Quality Indicator (CQI), and/or Signal-to-Interference-plus-Noise Ratio (SINR) for future CSI prediction instances. A WTRU may receive a reporting pattern and a type of compression from the NW, and then may compress and report RI/CQI for multiple CSI predictions.

For CSI prediction, the WTRU may predict one or more instances of future CSI (e.g., channel matrices or Precoding Matrix Indicators (PMIs)), Ĥ(t+1), . . . , Ĥ (t+P), by using the current and historical CSI measurements H(t−N), . . . , H(t). CSI prediction may reduce the CSI reporting overhead and may reduce the number of downlink CSI Reference Signals (CSI-RS). In some cases, the CSI prediction is WTRU-sided.

### SUMMARY

A method implemented by a wireless transmit receive unit (WTRU) may include receiving configuration information from a network, and receiving network assistance information for CSI prediction from the network (e.g., in different messages and/or at different time instances). The network assistance information may include any combination of a time instance of a historical reference Interference Measurement Resource (IMR) set, a coefficient for interference scaling relative to the historical reference IMR set, or an indication of a future expected blockage. The indication of the future expected blockage may include any combination of blockage information embedded into the coefficient for interference scaling, a condition used to determine blockage information, or an indication of a likelihood of a blockage at a future instance. The configuration information may include an indication of the channel measurement resources for determining CSI measurements and an indication of the IMRs for determining quality-based metrics.

The method may include determining historical channel measurements based on a plurality of measurement resources. The historical channel measurements may include the quality-based metrics and the CSI measurements. For example, the method may include determining quality-based metrics based on Interference Measurement Resources (IMRs) and CSI measurements based on channel measurement resources.

The method may include determining historical channel measurements based on configured Interference Measurement Resources (IMRs) and Channel Measurement Resources (CMRs).

The method may include determining a CSI prediction value for a future CSI prediction instance based on the historical channel measurements, for example, based on historical CSI measurements.

The method may include determining a quality-based metric for the future CSI prediction instance based on the historical channel measurements and the network assistance information. The quality-based prediction metric for the future CSI prediction instance comprises one or more of a rank indication (RI), a channel quality indicator (CQI) or a Signal-to-Interference-plus-Noise Ratio (SINR) for the future CSI prediction instance. The method may include sending an indication of the quality-based metric for the future CSI prediction instance to the network. In some examples, the CSI prediction value for the future CSI prediction instance is based on the CSI measurements of the historical channel measurements. In some examples, the quality-based metric for the future CSI prediction instance is based on the quality-based metrics of the historical channel measurements and the network assistance information.

In some examples, the network assistance information comprises a time instance of a historical reference IMR and a coefficient for interference scaling relative to the historical reference IMR. In such instance, determining the quality-based metric for the future CSI prediction instance may include determining an estimated interference value for the future CSI prediction instance based on the coefficient for interference scaling and the historical reference IMR.

In some examples, the network assistance information comprises an indication of future expected blockages. In such examples, determining the quality-based metric for the future CSI prediction instance may include determining a decreased Rank Indicator (RI) quality-based metric based on the indication of future expected blockages.

In some examples, determining the quality-based metric for the future CSI prediction instance may include predicting a Rank Indicator (RI) quality-based metric or a Channel Quality Information (CQI) quality-based metric for the future CSI prediction instance based on Artificial Intelligence Machine Learning (AIML) model. In such examples, the AIML model may have inputs that include one or more of: the CSI prediction value, a Signal-to-Interference-plus-Noise Ratio (SINR), an estimated interference, a WTRU trajectory, or an indication of future expected estimated blockages.

A wireless transmit receive unit (WTRU) may include a processor configured to receive configuration information from a network, and receive network assistance information for CSI prediction from the network. The network assistance information may include any combination of a time instance of a historical reference Interference Measurement Resource (IMR) set, a coefficient for interference scaling relative to the historical reference IMR set, or an indication of a future expected blockage. In some examples, the indication of the future expected blockage comprises one or more of: blockage information embedded into the coefficient for interference scaling, a condition used to determine blockage information, or an indication of a likelihood of a blockage at a future instance. The configuration information may include an indication of the channel measurement resources for determining the CSI measurements and an indication of the IMRs for determining the quality-based metrics.

The processor may be configured to determine historical channel measurements based on a plurality of measurement resources. For instance, the processor may be configured to determine quality-based metrics based on Interference Measurement Resources (IMRs) and CSI measurements based on channel measurement resources, wherein the historical channel measurements comprise the quality-based metrics and the CSI measurements (e.g., historical quality-based metrics and historical CSI measurements).

The processor may be configured to determine a CSI prediction value for a future CSI prediction instance based on the historical channel measurements. For example, the processor may be configured to determine the CSI prediction value for the future CSI prediction instance based on the CSI measurements of the historical channel measurements.

The processor may be configured to determine a quality-based metric for the future CSI prediction instance based on the historical channel measurements and the network assistance information. For example, the processor may be configured to determine the quality-based metric for the future CSI prediction instance based on the quality-based metrics of the historical channel measurements and the network assistance information. The quality-based prediction metric for the future CSI prediction instance may include one or more of a rank indication (RI), a channel quality indicator (CQI) or a Signal-to-Interference-plus-Noise Ratio (SINR) for the future CSI prediction instance. The processor may be configured to send an indication of the quality-based metric for the future CSI prediction instance to the network.

In some examples, the network assistance information may include a time instance of a historical reference IMR and a coefficient for interference scaling relative to the historical reference IMR. In such examples, the quality-based metric for the future CSI prediction instance may include an estimated interference value for the future CSI prediction instance that is determined based on the coefficient for interference scaling and the historical reference IMR.

In some examples, the network assistance information comprises an indication of future expected blockages. In such examples, the quality-based metric for the future CSI prediction instance may include a decreased Rank Indicator (RI) quality-based metric that is determined based on the indication of future expected blockages.

In some examples, the processor is configured to determine the quality-based metric for the future CSI prediction instance based on a Rank Indicator (RI) quality-based metric or a Channel Quality Information (CQI) quality-based metric using an Artificial Intelligence Machine Learning (AIML) model. The AIML model may have inputs that include one or more of: the CSI prediction value, a Signal-to-Interference-plus-Noise Ratio (SINR), an estimated interference, a WTRU trajectory, or an indication of future expected estimated blockages.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

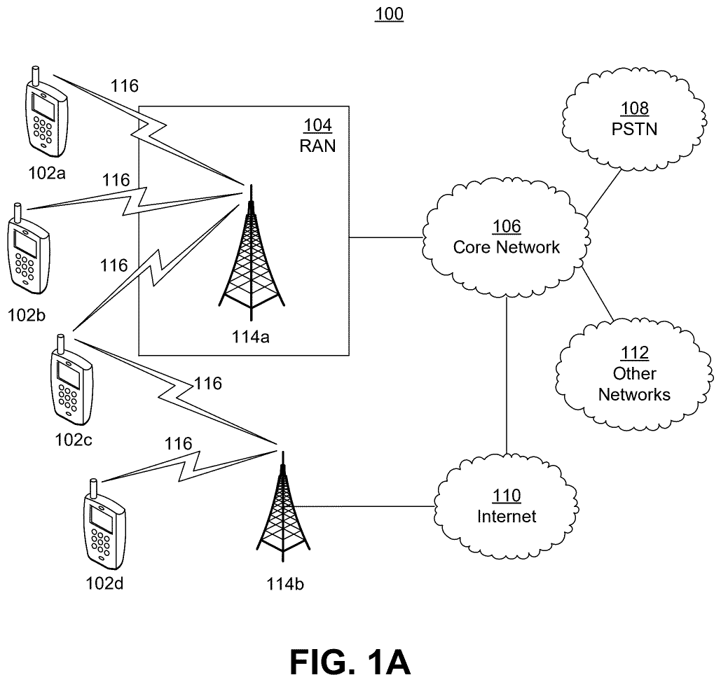

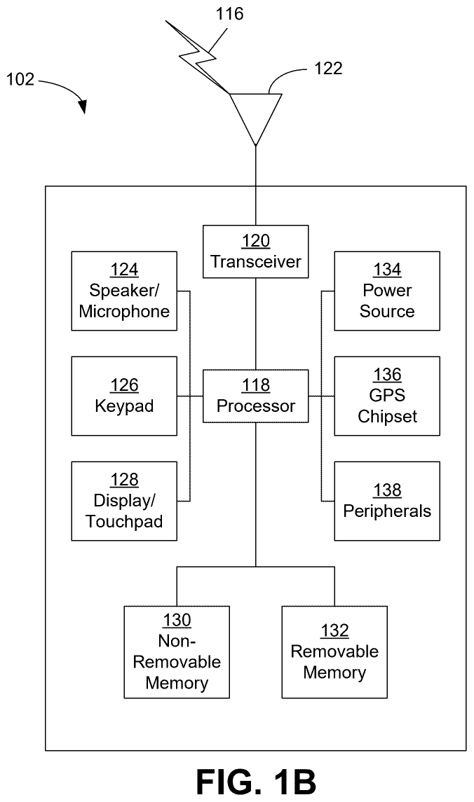

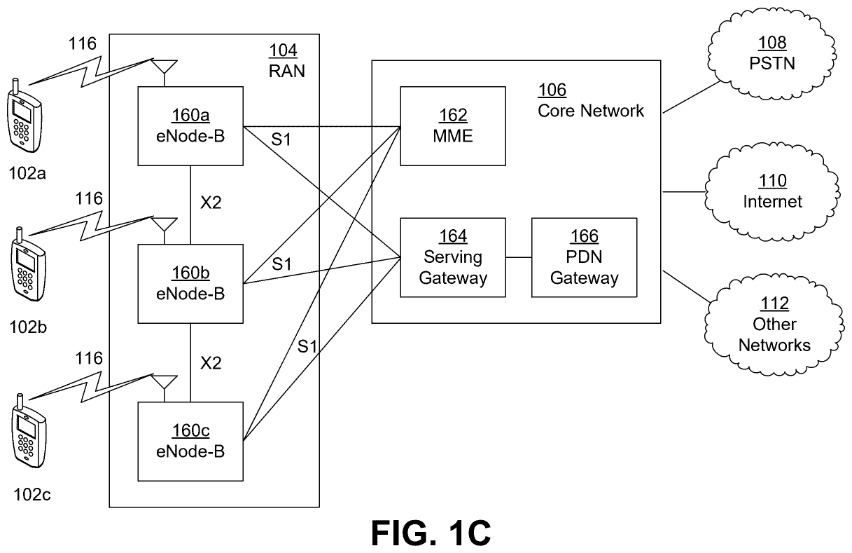

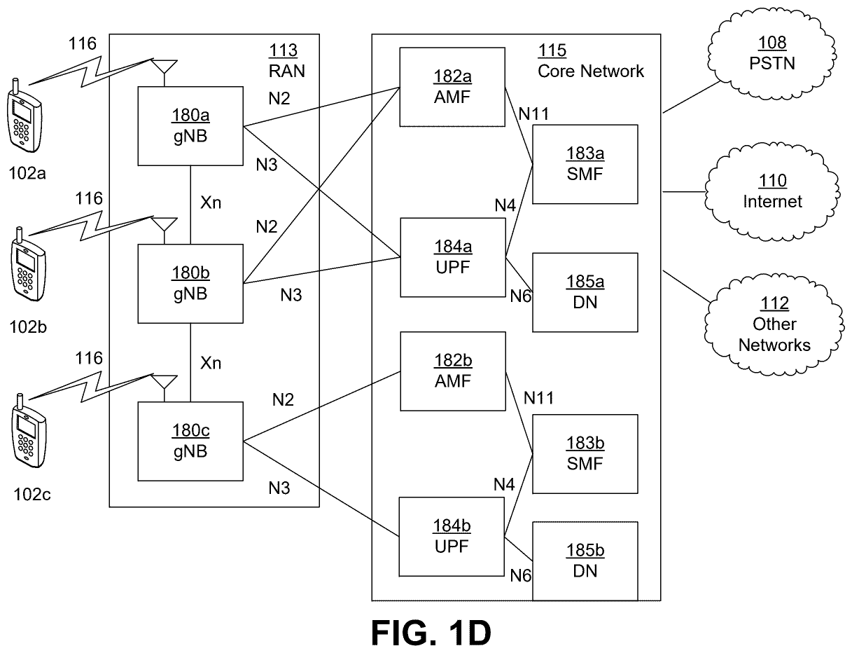

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may perform multiple Channel State Information (CSI) prediction(s), receive reference IMR set(s), receive assistance information (e.g., historical time instances associated with reference IMR sets) from the network (NW), and then may compute estimated interference and predict quality-based metrics (e.g., Rank Indicator (RI), Channel Quality Indicator (CQI), and/or Signal-to-Interference-plus-Noise Ratio (SINR)) for future CSI prediction instances. A WTRU may receive a reporting pattern and a type of compression from the NW, and then may compress and report RI/CQI for multiple CSI predictions.

For CSI prediction, the WTRU may predict one or more instances of future CSI (e.g., channel matrices or Precoding Matrix Indicators (PMIs)), Ĥ(t+1), . . . , Ĥ(t+P), by using the current and historical CSI measurements H(t−N), . . . , H(t). CSI prediction may reduce the CSI reporting overhead and may reduce the number of downlink CSI Reference Signals (CSI-RS). In some cases, the CSI prediction is WTRU-sided.

In examples, there may be a codebook defined for multiple predicted CSI (N4 denoting the number of future prediction instances). In the basic feature, one Channel Quality Indicator (CQI) is reported for N4 multiple predicted CSI, and in the optional feature maximum 2 CQI values are reported.

A WTRU with multiple CSI prediction capability may need to report Rank Indicator (RI) and CQI for each predicted CSI to improve the performance. However, RI/CQI may be impacted by interference (e.g., SINR, neighboring cells, blockage, etc.). Methods on predicting and compressing multiple RI/CQI for future instances are not defined in the relevant 3GPP studies.

Predicting RI/CQI at the WTRU may be more challenging than predicting a channel matrix or eigenvector, for example, because predicting RI/CQI may involve the WTRU predicting future interference, of which the WTRU may have no control. The WTRU may benefit from NW assistance information related to future interference levels to help predict RI/CQI.

A WTRU may perform multiple CSI predictions, receive one or more reference Interference Measurement Resource (IMR) set(s), receive assistance information (e.g., historical time instances associated with reference IMR sets) from the network to compute estimated interference, and/or predict quality-based metrics (e.g., RI/CQI/SINR) for future CSI prediction instances. The WTRU may predict CSI for multiple CSI prediction instances, and may receive a configuration for a quality-based metric (e.g., RI/CQI/SINR) predictions. The assistance information and associated configurations (e.g., received from the NW) may be, for example: historical time instances of reference IMR sets, interference scaling coefficients, and/or expected blockage in future instances. The WTRU may receive one or more measurement resources for receiving CSI-RS and/or assistance information.

The WTRU may receive one or more measurement resources. The WTRU may receive IMRs (e.g., CSI Reference Signal (CSI-RS) (e.g., non-zero-power (NZP) and/or zero-power (ZP))) and/or channel measurement resources (CMRs) (e.g., NZP CSI-RS). Based on the measurement resources, the WTRU may determine historical channel measurements for one or more instances and/or determine a historical IMR measurement for one or more instances.

The WTRU may receive NW assistance information. In examples, the NW assistance information may comprise one or more historical time instances of reference IMR sets. For example, a set of indices of size N (e.g., N=4) linking previous IMR (e.g., ZP and/or NZP CSI-RS) measurements for N instances (e.g., [−100 ms, −40 ms, −20 ms, −50 ms]) to M future CSI prediction instances (e.g., [5 ms, 10 ms, 15 ms, 20 ms]). In examples, the NW assistance information may comprise one IMR set for periodic interference, and/or an IMR set for aperiodic interference.

In examples, the NW assistance information may comprise one or more sets of coefficients for interference scaling relative to a historical reference IMR. For example, the NW assistance information may comprise one coefficient per future CSI prediction instance with respect to a reference IMR measurement for one (e.g., the latest) instance.

In examples, the NW assistance information may comprise an indication of one or more expected blockage(s) for future instances. For example, the blockage information may be embedded into the coefficients. For example, the WTRU may determine the blockage information based on the assistance information and/or one or more associated conditions. The conditions may comprise, for example, no change in location, no change in speed, specific location, etc. For example, the NW assistance information may comprise an indication of a likelihood of a blockage in future instances (e.g., a probability).

The WTRU may perform channel prediction to determine CSI prediction values for a plurality of (e.g., M) future CSI prediction instances based on the determined historical channel measurements for one or more instances.

The WTRU may determine one or more quality-based metric(s) (e.g., RI/CQI/SINR) for each of the M future CSI prediction instances. For example, the WTRU may determine one or more quality-based metric(s) based on historical IMR measurements for one or more instances. For example, the WTRU may determine one or more quality-based metric(s) based on a predicted SINR based on the assistance information. For example, the WTRU may determine one or more quality-based metric(s) based on determining an estimated interference for each of the M future CSI prediction instances based on the reference IMR set indicated by the NW (e.g., P₁[t+5 ms, t+10 ms, t+15 ms, t+20 ms]˜P₁[t−100 ms, t−40 ms, t−20 ms, t−50 ms]). For example, the WTRU may determine one or more quality-based metric(s) based on determining estimated interference for each of the M future CSI prediction instances based on the Interference coefficients and the reference IMRs (e.g., P₁[t+5 ms, t+10 ms, t+15 ms, t+20 ms]˜P₁[t]×[0.9 1.1 1.2 1.3]). For example, the WTRU may determine one or more quality-based metric(s) based on an expected blockage in the trajectory (e.g., the WTRU may decrease a quality-based metric (e.g., RI) for future instances with estimated blockage, etc.). For example, the WTRU may determine one or more quality-based metric(s) based on a quality-based metric (e.g. RI/CQI) predicted with an Artificial Intelligence Machine Learning (AIML) model (e.g., with inputs comprising one or more of predicted CSI values, measured or predicted SINR, determined estimated interference, WTRU trajectory, estimated blockage, etc.).

The WTRU may report the one or more sets of predicted quality-based metrics (e.g. RI/CQI/SINR) based on the received assistance information. In some examples, the WTRU may determine the accuracy of the NW assistance information based on measuring the accuracy of quality-based metric prediction. In examples, the WTRU may report an indicator of the accuracy of NW assistance information. In some cases, using the NW assistance information, the WTRU may predict and/or report RI/CQI for predicted CSI more accurately, which may improve the end-to-end system throughput performance.

A WTRU may receive assistance information for RI/CQI prediction. The WTRU may receive a configuration information comprising a configuration of the NW assistance information.

In examples, a WTRU capable of predicting CSI for multiple CSI prediction instances may receive configuration information indicating a quality-based metric (e.g., RI/CQI/SINR) for prediction. The quality-based metric may be a metric or reporting quantity, which may be used for scheduling for downlink transmission. As used herein, the quality-based metric may be interchangeably used with CSI reporting quantity, reporting quantity, CSI reporting, channel quality metric, channel quality information, and/or channel information, including interference. The configuration information may include one or more of the following.

The configuration information may comprise an indication of a type of assistance information to be received from the NW. The WTRU may use assistance information from the NW to improve the prediction of a quality-based metric (e.g., RI, CQI, SINR, etc.). The NW assistance information may comprise one or more of the following.

The NW assistance information may comprise one or more historical time instances of reference IMR sets. If the WTRU is configured with this type of assistance information, then the WTRU may receive one or more sets of indicators for historical time instances for historical reference IMR sets. In examples, the indicators could be in the form of a time stamp, resource indices (e.g., zero-power or non-zero-power CSI-RS resource index, CSI-RS resource set index), relative index with respect to a reference time, etc. In some examples, the WTRU may be configured with specific historical IMR sets and assistance information comprising time indicators referring to the indices of the specific set of historical IMRs. In some examples, the WTRU may be configured with a window size where the assistance information comprises time indices referring to the historical IMRs within the window. In some examples, the WTRU may be configured to receive a first set of historical time indices of IMR set for periodic interference, and a second set of historical time indices of IMR set for aperiodic interference. In some examples, the WTRU may be configured with and/or may determine a downlink (DL) resource type associated with the downlink resource type for which the WTRU may predict a quality-based metric. For example, one or more downlink resource types may be defined, configured, or used, wherein downlink resource type may include a slot type (e.g., DL only slot, flexible slot, Sub-Band Full Duplex (SBFD) slot, and non-SBFD slot) or a slot number. When a WTRU predicts a quality-based metric in a specific downlink resource type, the WTRU may use IMR configured or used the same type of downlink resource type in the historical measurement.

The NW assistance information may comprise one or more interference scaling coefficients. If the WTRU is configured with this type of assistance information, then the WTRU may receive one or more sets of scalar coefficients and one or more indicator of a timing instance of a IMR set. E.g., the scalar coefficients may be in the form of full precision scalar values between a min and max value (e.g., 0 and 1), quantized scalar values between a min and max value (e.g., 0 and 1), etc. In examples where the quality-based metric is predicted for one or more future slots, the scaling coefficient may be provided and/or configured per future slot, or a common scaling coefficient may be provided and/or configured for one or more (e.g., all) future slots within prediction window. Hereinafter, a future slot may be referred to as a slot located within a prediction window for which the WTRU may predict quality-based metric. A measurement slot (e.g., current slot) may be referred to as a slot in which the WTRU may perform measurement of CSI-RS and use the measurement to predict CSI and its associated quality metric for the future slots. The predict window may start from the measurement slot with an offset (e.g., offset=1).

The NW assistance information may comprise an indication of one or more expected blockage(s) for future instances. If the WTRU is configured with this type of assistance information, the WTRU may receive indicators of expected blockage in future time instances. For example, the indicators may be in the form of one or more probability values for future time instances, one or more binary values for future time instances to represent the expected blockage in future instances (e.g., 0 for no-blockage, 1 for blockage), etc. The NW assistance information may comprise one or more combinations of historical time instances of reference IMR sets and interference scaling coefficients.

The configuration information may comprise resources for receiving CSI-RS. The WTRU may receive indicators on CSI-RS resources (e.g., NZP and ZP CSI-RS) for channel and interference measurements. The configuration information may comprise resources for receiving assistance Information. The WTRU may receive indicators on the resources to receive assistance information. For example, the WTRU may receive a configuration to receive assistance information over control channels (e.g., PDCCH) and/or data channels (e.g., PDSCH). The configuration information may comprise neighboring cell loading information (e.g., fully loaded, 80% loaded, 40% loaded, etc.). In examples, if neighboring cells are fully loaded, the WTRU may reuse a historical measurement of an IMR as it is. In examples, if neighboring cells are 80% loaded, a first scaling coefficient may be used. In examples, if neighboring cells are loaded 40% loaded, a second scaling coefficient may be used, and so forth.

The WTRU may be provided with NW assistance information dynamically. For example, when a WTRU is triggered to report CSI aperiodically (e.g., via DCI) for CSI prediction, the WTRU may be provided with NW assistance information to determine quality-based metrics, for instance, for future CSI prediction instances. As used herein, assistance information or NW assistance information may be interchangeably used with IMR set, interference scaling coefficient, CSI-RS resource identity, and/or measurement resource identity. One or more IMR set(s) may be indicated to the WTRU from the network in the triggering message (e.g., DCI) for CSI reporting. In examples, an IMR set may be indicated for one or more (e.g., all) CSI prediction instances (e.g., future slots within the CSI prediction window), or one IMR set per CSI prediction instance. The number of CSI prediction instances (e.g., number of future slots for which the WTRU will predict CSI) may be indicated in the triggering message. If NW assistance information (e.g., IMR sets) is not present in the triggering message (e.g., not configured by network), a default IMR set may be used for quality-based metric estimation or determination. In some examples, the default IMR set may be the IMR set configured for the measurement slot. In some examples, the default IMR set may be IMR configured or used for the same type of downlink resource. In some examples, the default IMR set may be configured IMR set via a higher layer signaling.

The WTRU may predict RI/CQI using NW assistance information. The WTRU may be configured for predicting CSI for multiple CSI prediction instances. The WTRU may receive IMR(s) (e.g., NZP/ZP CSI-RS) and/or Channel Measurement Resources (CMR) (e.g., NZP CSI-RS). The WTRU may compute the CSI quality-based metrics (e.g., RI, CQI, SINR) based on the received IMRs, and may compute the CSI based on the channel measurement resource(s) (e.g., channel matrix, eigenvector, etc.).

The WTRU may associate time instances with the quality-based metric(s) and CSI. The WTRU may store historical quality-based metrics and CSI together with the associated time instances. Based on the received configuration, the time instances associated with the quality-based metrics and CSI may be one of the following. The time instances may comprise a time stamp. For example, the WTRU may associate a time stamp to the computed quality-based metrics and CSI, e.g., the time stamp of the slot, symbol, etc. corresponding to the received IMR or the channel measurement resource.

The time instances may comprise a resource index. For example, the WTRU may associate a resource index to the computed quality-based metrics and CSI (e.g., CSI-RS resource indicator (CRI)), corresponding to the received IMR or the channel measurement resource.

The time instances may comprise a relative index with respect to a reference time or resource. For example, the WTRU may associate a relative index to the computed quality-based metrics and CSI. In examples, the relative index may be in terms of slot or symbol numbers (e.g., with respect to a reference slot, symbol, and/or resource index indicated by the NW (e.g., the latest IMR).

The WTRU may receive assistance information from the NW. The WTRU may use the assistance information from the NW to improve the prediction of quality-based metrics (e.g., RI, CQI, SINR, etc.). For example, the WTRU may receive one or more of the following as the assistance information from the NW.

The WTRU may receive assistance information comprising historical time instances of reference IMR (Interference Measurement Resource) sets as the assistance information. For example, the WTRU may receive a set of indices of size N linking historical received IMR (e.g., ZP and/or NZP CSI-RS) measurements for N instances to M future CSI prediction instances. For example, the WTRU may receive N=4 indices that corresponds to the IMR received at historical time instances (e.g., [−100 ms, −40 ms, −20 ms, −50 ms]). Each index may correspond a relative time difference with respect to the latest IMR. The N historical time instances may be linked to M=4 future CSI prediction instances (e.g., [5 ms, 10 ms, 15 ms, 20 ms]). In some cases, The WTRU may receive N time stamps that correspond to the time instances of the historical IMR set. The N time stamps may be linked to M future CSI prediction time instances. In some cases, the WTRU may receive N CSI-RS resource indicators that corresponds to the time instances of historical IMR sets. The N resource indicators may be linked to M future CSI prediction time instances. In some cases, the WTRU may receive a first set of historical time indices of IMR set for periodic interference (e.g., a fixed set) to be used for one or more of the future CSI prediction tasks. The WTRU may further receive a second set of historical time indices of IMR set for aperiodic interference (e.g., a dynamic set) for each of the CSI prediction tasks.

In some examples, the WTRU may receive (e.g., N=4) indices that correspond to the IMR received at historical time instances (e.g., [−100 ms, −40 ms, −20 ms, −50 ms]) where each index may correspond a relative time difference with respect to the latest IMR. The N historical time instances may be linked to M=1 CSI prediction instance. In this case the WTRU may still compute multiple quality-based metrics per one prediction instance which may represent different interference hypotheses for the same prediction instance.

The WTRU may receive assistance information comprising interference scaling coefficients and a historical timing indicator to reference IMR set as the assistance information. The WTRU may receive one or more interference scaling coefficients. For example, one coefficient to be used for all M future CSI prediction instances, or one coefficient per each future CSI prediction instances. For example, the scalar scaling coefficients may be in the form of full precision scalar values between a min and max value (e.g., 0 and 1), or quantized scalar values between a min and max value (e.g., 0 and 1), etc. In examples, the WTRU may receive one scalar coefficient (e.g., [0.3]), or N scalar coefficients (e.g., [0.9 1.1 1.2 1.3]). The scalar coefficients may be linked to M future CSI prediction time instances (e.g., [5 ms, 10 ms, 15 ms, 20 ms] for M=4). The WTRU may also receive a historical timing indicator to a reference IMR set, for example, in the form of a time stamp, resource index, relative index, etc.

The WTRU may receive assistance information comprising expected blockage indicators in future instances. In examples, the expected blockage indicators may be in the form of a statistical information, for example, one or more probability values for future time instances (e.g., [0.9 0.5 0.1 0.1] for N=4), or N=1 probability value for M future CSI prediction instances. In examples, the expected blockage indicators can be in the form of one or more binary values for future time instances to represent the expected blockage in future instances (e.g., 0 for no-blockage, 1 for blockage). For example, [0 0 1 1] for N=4, or N=1 associated with a binary value. The expected blockage indicators may be linked to M future CSI prediction time instances (e.g., [5 ms, 10 ms, 15 ms, 20 ms] for M=4). In some cases, the expected blockage indicators may be included in the received interference scaling coefficients. In some cases, the expected blockage indicators may be further conditioned on one or more associated conditions, e.g., no change in location, no change in speed, specific location, etc.

The WTRU may perform channel prediction to determine CSI (e.g., channel matrix or eigenvalue) prediction values for M future CSI prediction instances based on the historical channel measurements for one or more instances. The WTRU may use a prediction model. For example, a one-sided AIML model with historical channel measurements as the input and one or more future CSI predictions as the output.

The WTRU may determine one or more quality-based metric (e.g., RI/CQI/SINR) for each of the M future CSI prediction instances based on one or more of the following. The WTRU may determine one or more quality-based metric based on historical IMR measurements for one or more instances. The WTRU may determine quality-based metrics (e.g., RI/CQI/SINR), as a function of the historical IMR measurements.

The WTRU may determine one or more quality-based metric based on predicted SINR based on the assistance information. The WTRU may determine quality-based metrics (e.g., RI/CQI/SINR), as a function of the predicted SINR determined based on the assistance information.

The WTRU may determine one or more quality-based metric based on determining estimated interference for each of the M future CSI prediction instances based on the time instances of reference IMR set indicated by the NW. In examples, for N time instances of historical IMR sets [t−100 ms, t−40 ms, t−20 ms, t−50 ms] and M future CSI predictions configured at [t+5 ms, t+10 ms, t+15 ms, t+20 ms], the WTRU determines the estimated future interference powers P₁[t+5 ms, t+10 ms, t+15 ms, t+20 ms] proportional to the historical interference powers P₁[t−100 ms, t−40 ms, t−20 ms, t−50 ms].

The WTRU may determine one or more quality-based metric based on determining estimated interference for each of the M future CSI prediction instances based on the Interference coefficients and the reference IMRs. For example, for M future CSI predictions configured at [t+5 ms, t+10 ms, t+15 ms, t+20 ms], N=4 interference scaling coefficients as [0.9 1.1 1.2 1.3], and latest IMR as the reference, e.g., P₁[t], the WTRU determines the estimated future interference powers P₁[t+5 ms, t+10 ms, t+15 ms, t+20 ms] proportional to the scaling coefficients and latest IMR resource so that P₁[t+5 ms, t+10 ms, t+15 ms, t+20 ms] ˜ P₁[t]×[0.9 1.1 1.2 1.3].

The WTRU may determine one or more quality-based metric based on determining estimated interference for each of the M future CSI prediction instances based on downlink resource type associated with each future CSI prediction instances. In examples, one or more historical measurement of the interference associated with the same type of downlink resource type may be used. For example, if a first downlink resource type (e.g., SBFD slot) is associated with the first CSI prediction instance, the historical interference measurement for the first downlink resource type may be used as estimated interference; if a second downlink resource type (e.g., non-SBFD slot) is associated with the second CSI prediction instance, the historical interference measurement for the second downlink resource type may be used as estimated interference, and so on.

The WTRU may determine one or more quality-based metric based on determining RI based on an expected blockage indicator. For example, the WTRU may select the lowest value for a quality-based metric (e.g., RI) for future instances where the received blockage probability is greater than a threshold, or the received blockage indicator is 1.

The WTRU may determine one or more quality-based metric based on determining the predictions for the quality-based metrics (e.g. RI/CQI) with an AIML-model. The AIML model may take as input one or more of predicted CSI values, measured or predicted SINR, determined estimated interference, WTRU trajectory, estimated blockage, etc. and outputs the predicted one or more quality-based metrics.

The WTRU may measure the accuracy of the NW assistance information. The WTRU may compare the current interference measured with actual received IMRs with the assistance information received from the NW in the past corresponding to the same time instance. For example, the accuracy may be represented as the percentage difference of the indicated interference by the NW and actual interference measured.

In some cases, the WTRU may report the predicted RI/CQI (e.g., to the network). The WTRU may determine one or more quality-based metric (e.g., RI, CQI, SINR, interference measurement) for one or more current or future time instance. The determination may be based on WTRU measurements of one or more RS (e.g., NZP CSI-RS, ZP CSI-RS) or NW assistance information. The WTRU may transmit a feedback report that may include a quality-based metric applicable to at least one of: A current or future time instance (e.g., where the applicable time instance may be indicated in the feedback report); and/or a set of current or future time instances, e.g., where the applicable set of time instances may be indicated in the feedback report. In an example, a single value of a quality-based metric may be applicable to all time instances in the set of current or future time instances.

The WTRU may transmit feedback for multiple values of one or more quality-based metrics for a time instance, where each of the multiple values may be associated with different measurements of NW assistance information. For example, a WTRU may report N values of a quality-based metric, where each N is for a different interference hypothesis as defined by N different assistance information values. For example, a first value of a quality-based metric for a time instance may be determined from a first set of RS measurements with a first set of weights, and a second value of a quality-based metric for a time instance may be determined from a second set of RS measurements with a second set of weights.

The WTRU may transmit a feedback report that includes a confidence metric for one or more quality-based metric for one or more current or future time instances. For example, the WTRU may report at least one of: a confidence value (e.g., likelihood of being accurate); a confidence interval or range of values that have a confidence value greater than a threshold; a confidence interval or range of values that cover the accurate value more than a configurable percent of time; and/or a prediction quality metric associated with the predicted quality-based metric.

The WTRU may determine the accuracy of the NW assistance information. For example, the WTRU may determine the accuracy of a predicted quality-based metric (e.g., predicted based on NW assistance) for a time instance with a measurement of the quality-based metric in the time instance. The WTRU may compare the value of a predicted quality-based metric for a time instance with a measurement of the quality-based metric in the time instance. The WTRU may report one or more of the following. The WTRU may report an absolute difference between the predicted value of a quality-based metric for a time instance and the measured value of a quality-based metric for the time instance. The WTRU may report a comparison of an absolute difference and a threshold. For example, the WTRU may report if the absolute difference between a predicted value of a quality-based metric for a time instance and a measured value of a quality-based metric for the time instance is greater than or less than a threshold. The WTRU may report a difference value (e.g., absolute or compared to threshold) per measurement resource. For example, the WTRU may receive NW assistance to scale a first measurement in a first time instance on a first measurement resource by a value x. The WTRU may determine a second measurement in a second time instance on the first measurement resource. The WTRU may determine and report the difference between the scaled first measurement to the second measurement. The WTRU may report multiple such differences determined from measurements on multiple measurement resources. The WTRU may report a validation of a blockage event occurring.

The WTRU may determine the accuracy of the NW assistance information per time instance. In some cases, the WTRU may determine the accuracy (e.g., average accuracy) of NW assistance for multiple time instances.

The WTRU may determine to report the determined accuracy of the NW assistance information based on one or more of the following. The WTRU may determine to report the determined accuracy of the NW assistance information based on Accuracy value. For example, the WTRU may report the accuracy if the value is above or below a threshold. The WTRU may determine to report the determined accuracy of the NW assistance information based on an indication from the network (e.g., a gNB). For example, the WTRU may receive an aperiodic accuracy report request. The WTRU may determine to report the determined accuracy of the NW assistance information based on timing. For example, the WTRU may report one or more accuracy value based on timing (e.g., periodic reporting, or timing with respect to the time instance of the accuracy value, or based on an aperiodic request). The WTRU may determine to report the determined accuracy of the NW assistance information based on a feedback resource. For example, the WTRU may report the accuracy as a function of the available payload of a feedback resource. The WTRU may determine to report the determined accuracy of the NW assistance information based on a HARQ-NACK rate. For example, if a WTRU determines a rate of HARQ-NACK to be greater than (or less than) a threshold (e.g., over a configurable number of time instances), the WTRU may report the accuracy. The WTRU may determine to report the determined accuracy of the NW assistance information based on link adaptation. For example, a WTRU may determine that a TBS or MCS has changed more than a threshold value for a set of transmissions or retransmissions. Based on this, the WTRU may report accuracy.

The WTRU may report an update for one or more previously reported quality-based metric for one or more future time instances. For example, the WTRU may determine that the accuracy of one or more previously reported quality-based metrics for one or more time instances in a set of time instances is below a threshold. The WTRU may report an updated value for one or more previously reported quality-based metrics for one or more future time instances in the set of previously reported time instances. The updated values for the one or more previously reported quality-based metrics may be determined from a new set of measurements and/or a new set of NW assistance information.

The WTRU may report one or more quality-based metrics for a CSI prediction instance with different interference assumptions so that gNB may determine a proper quality-based metric based on interference environment at the point of scheduling the WTRU. For example, a WTRU may be configured with one or more interference level assumptions (e.g., historical IMRs, scaling coefficients, neighboring cell loading) and the WTRU may report a set of quality-based metrics with configured interference level assumption for a specific CSI prediction instance, the gNB may use one of the quality-based metric with a specific interference level assumption which fits with the interference environment at the point of the scheduling of the WTRU.

A WTRU may compress and/or report RI/CQI for multiple predicted CSI. The WTRU may be configured for RI/CQI compression and CSI reporting. A WTRU capable of predicting multiple CSI instances receives configuration for reporting the RI/CQI for one or more of the multiple CSI predictions.

The configuration for reporting the RI/CQI may comprise a reporting pattern. The reporting may use the same pattern for RI/CQI and PMI, or in another solution, the RI/CQI reporting pattern may be different from the PMI reporting pattern. The reporting pattern may indicate the index of the reported RI/CQI and/or PMI within the CSI prediction window. In one solution, the reporting pattern may be indicated to the WTRU as a bitmap, where a value of “1” indicates the index of the RI/CQI (e.g., and/or PMI) to be reported, relative to the start of the prediction window. For example, for a prediction window length of M CSI samples (e.g., where M>1), the RI/CQI may be reported for every index within the CSI prediction window, for even/odd indices, or for a pre-defined pattern, where the pre-defined pattern may be a function of the prediction window length. In another solution, reporting patterns corresponding to different prediction window sizes may be pre-defined in tabular form, and the configured reporting pattern may be indicated as a table ID and an index in the table.

The configuration for reporting the RI/CQI may comprise a type of CQI table and/or the PMI codebook type for the predicted instances.

The configuration for reporting the RI/CQI may comprise RI/CQI compression type. The RI/CQI compression type may be a function of the measured channel conditions. For example, a type-1 (e.g., default) configuration for RI/CQI compression in the prediction window. Type-1 may comprise of, for each prediction instances, one wideband CSI (e.g., 4 bit) and per sub-band CSI (e.g., 2 bit); Type-1 reports a single RI for all instances in the prediction window. Type-1 may be used as the default RI/CQI compression type for single or multiple CSI predictions. For example, a type-2 configuration for RI/CQI compression in the prediction window. In examples, for a type-2 configuration, for the first prediction instance, the WTRU may report the wideband CQI, the per sub-band CQI, and the RI, while for each of the subsequent instances in the reporting window, the report may include the wideband differential CQI (e.g., 2 bit), the differential sub-band CQI (e.g., 1 bit) and the differential RI. Type-2 may be used for channel conditions with high Doppler or low coherence time. For example, a type-3 RI/CQI compression in the prediction window. For type-3, for the first prediction instance, the WTRU may report the wideband CQI, the per sub-band CQI, while for each of the subsequent instances in the reporting window, the report may include the differential sub-band CQI (e.g., 1 bit). Type-3 may include a single RI report for all prediction instances in the prediction window. Type-3 may be used for channel conditions with low Doppler or high coherence time. For example, a type-4 configuration RI/CQI compression in the prediction window. For Type-4, for each prediction instance, the WTRU may report the full sub-band CQI and the RI. Type-4 may be used for channels with high blockage probability. For example, a type-5 (e.g., hybrid) compression type. For type-5, for each prediction instance the WTRU may follow an indicated pattern (e.g., report/not report), and may use the configured RI/CQI report format.

The configuration for reporting the RI/CQI may be based on a method of determination of the RI/CQI compression type. For example, if the method of determination is NW configured, the NW may determine the RI/CQI compression type and configure the WTRU either semi-statically (e.g., via RRC), or dynamically (e.g., via DCI). For example, if the method of determination is WTRU assisted, the WTRU may determine the RI/CQI compression type as a function of the measured channel conditions, and the WTRU may report the determined compression type to the NW.

The configuration for reporting the RI/CQI may be based on parameters for the RI/CQI compression type determination. When the WTRU is configured to determine the RI/CQI compression type, the WTRU receives the measurement configuration to determine the compression type. The measurement configuration may include indication of metrics to be collected, for example Doppler, channel coherence time, TDCP (Time Domain Channel Property), blockage probability. The measurement configuration may include thresholds corresponding to the configured metric. For example, if the WTRU is configured to measure and report the channel coherence time, the WTRU may receive a first channel coherence threshold, whereby if the measured channel coherence time is lower than the first threshold, the WTRU determines to use type-2 as RI/CQI compression type. The WTRU may determine Type-3 as RI/CQI compression type when the measured channel coherence time is higher than a second channel coherence threshold, where the second channel coherence threshold is larger than the first channel coherence threshold. The WTRU may determine Type-1 (default) RI/CQI compression type, for example when the channel coherence time is between the first and the second channel coherence threshold. In examples, if the WTRU is configured to measure and report the TDCP, the WTRU may receive a first TDCP threshold and a second TDCP threshold to determine the RI/CQI compression type.

The WTRU may utilize procedures for RI/CQI compression of multiple predicted CSI. The WTRU may receive a configuration of an RI/CQI reporting pattern, and the RI/CQI compression type. If configured, the WTRU determines the RI/CQI compression type as a function of channel conditions. The WTRU compresses the predicted RI/CQI using the configured RI/CQI compression type. The WTRU reports the compressed RI/CQI and the determined RI/CQI compression type.

The WTRU may determine RI/CQI for multiple CSI prediction instances. The WTRU may determine multiple predicted CSIs for the configured prediction window. The WTRU may further compute the PMI based on the configured RI/CQI reporting patterns. For example, the WTRU may compute a type-II codebook PMI for a first reported instance (e.g., in the prediction window), and may compute type-I codebook PMI for a second reported instance. The WTRU may compute CSI quality-based metrics (e.g., RI/CQI) for each instance of the configured RI/CQI reporting patterns. For example, based on the received IMRs and the calculated PMIs.

The WTRU may determine a RI/CQI compression type. The WTRU may determine the RI/CQI compression type as a function of the measured channel conditions. The WTRU may measure the channel conditions (e.g., Doppler, coherence time, TDCP, estimated blockage rate) based on the received channel measurement resources (e.g. CSI-RS). If configured (e.g., when the method of determination of the RI/CQI compression type is “WTRU assisted”), the WTRU may determine the RI/CQI compression type as a function of the measured channel conditions.

In some cases, TDCP may be used as the metric for RI/CQI compression type determination. For example, the WTRU may be configured with a first TDCP threshold. If the measured TDCP exceeds the first threshold, the WTRU may determine to use type-3 (e.g., slow channel) for the RI/CQI compression type. The WTRU may be configured with a second TDCP threshold (e.g., where the second TDCP threshold is smaller than the first threshold). If the measured TDCP is smaller than the second TDCP threshold, the WTRU may determine to use type-2 (e.g., fast channel) as the RI/CQI compression type. If the measured TDCP is between the second and the first TDCP threshold, the WTRU may determine type-1 (e.g., default) as the RI/CQI compression type.

In some cases, the WTRU may use the doppler spread for RI/CQI compression type determination. For example, the WTRU may be configured with a first doppler threshold. If the measured doppler exceeds a first doppler threshold, then the WTRU may determine to use type-2 (e.g., fast channel) as the RI/CQI compression type. The WTRU may be configured with a second doppler threshold. In examples, the second doppler threshold may be smaller than the first doppler threshold. For example, if the measured doppler is smaller than the second doppler threshold, the WTRU may determine to use type-3 (e.g., slow channel) as the RI/CQI compression type. For example, if the measured doppler is between the first and second doppler thresholds, the WTRU may determine to use type-1 (e.g., default) as the RI/CQI compression type.

The WTRU may use the blockage probability for RI/CQI compression type determination. In examples, the WTRU may be configured with a blockage threshold. If the measured blockage probability exceeds the configured threshold, the WTRU may determine to use type-4 as the RI/CQI compression type. If the measured blockage probability is lower than the configured blockage threshold, the WTRU may use an additional metric to select a more efficient compression type.

The WTRU may report the compressed RI/CQI (e.g., to the network). The WTRU may report at least one of: compressed quality-based metric (e.g., RI, CQI, SINR, interference measurement); compression type (e.g., indication of a pre-configured compression type, or payload for each measurement type); other CSI metric (e.g., PMI, layer indicator (LI), CRI, Angle of Arrival, Angle of Departure, Doppler shift, doppler spread, delay, delay spread, etc.); a value of a measurement that is used to determine a compression type for a feedback report (e.g., WTRU speed, coherence time, estimated or predicted blockage, blockage probability, etc.); and/or one or more parameters of a compression type. For example, the WTRU may report the type of feedback components (WB or SB), the number of each feedback component type, the number of bits per feedback component, the number or size of subbands, and/or absolute or differential values.

A WTRU may report a quality-based metric compression type based on the compression type changing (e.g., from a previously reported compression type). Alternative or additionally, the WTRU may report a quality-based metric compression type based on timing (e.g., every feedback instance, periodically, upon request from gNB, based on a configurable pattern, and/or based on reporting instances). A compression type may be determined and/or reported per current or future time instance (e.g., the time instance for which a compressed measurement is applicable). A compression type may be determined and/or reported per set of time instances.

A WTRU capable of predicting CSI for multiple CSI prediction instances may receive a configuration associated with quality-based metric (e.g., RI/CQI/SINR) prediction. The WTRU may receive assistance information. The type of assistance information received from the NW, and associated configurations, may include any combination of historical time instances of reference IMR sets, interference scaling coefficients, and/or expected blockage in future instances. The WTRU may receive measurement resources comprising resources for receiving CSI-RS and assistance information.

The WTRU may receive one or more measurement resources. The WTRU may receive IMRs (e.g., CSI Reference Signal (CSI-RS) (non-zero-power (NZP) and/or zero-power (ZP))) and/or channel measurement resources (e.g., NZP CSI-RS). Based on the measurement resources, the WTRU may determine historical channel measurements for one or more instances and/or determine a historical IMR measurement for one or more instances.

The WTRU may receive assistance information. In examples, the NW assistance information may comprise one or more historical time instances of reference IMR sets. For example, a set of indices of size N (e.g., N=4) linking previous IMR (e.g., ZP and/or NZP CSI-RS) measurements for N instances (e.g., [−100 ms, −40 ms, −20 ms, −50 ms]) to M future CSI prediction instances (e.g., [5 ms, 10 ms, 15 ms, 20 ms]). In examples, the NW assistance information may comprise one IMR set for periodic interference, and/or an IMR set for aperiodic interference. For example, the WTRU may receive one set for periodic interference, and another set for aperiodic interference.

In examples, the NW assistance information may comprise one or more sets of coefficients for interference scaling relative to a historical reference IMR. For example, the NW assistance information may comprise one coefficient per future CSI prediction instance with respect to a reference IMR measurement for one (e.g., the latest) instance. In examples, the assistance information may comprise one or more indications of expected blockage in future instances. An indication of expected blockages may, in examples, embedded into the coefficients, determined by the WTRU based assistance information and one or more associated conditions (e.g., no change in location, no change in speed, specific location, etc.), and/or in the form of a likelihood of blockage in future instances.

The WTRU may perform channel prediction to determine CSI prediction values for M future CSI prediction instances based on the determined historical channel measurements for one or more instances.

The WTRU may determine one or more quality-based metric(s) (e.g., RI/CQI/SINR) for each of the M future CSI prediction instances. For example, the WTRU may determine one or more quality-based metric(s) based on historical IMR measurements for one or more instances. For example, the WTRU may determine one or more quality-based metric(s) based on a predicted SINR based on the assistance information. For example, the WTRU may determine one or more quality-based metric(s) based on determining an estimated interference for each of the M future CSI prediction instances based on the reference IMR set indicated by the NW (e.g., P₁[t+5 ms, t+10 ms, t+15 ms, t+20 ms] ˜ P/[t−100 ms, t−40 ms, t−20 ms, t−50 ms]). For example, the WTRU may determine one or more quality-based metric(s) based on determining estimated interference for each of the M future CSI prediction instances based on the Interference coefficients and the reference IMRs (e.g., P₁[t+5 ms, t+10 ms, t+15 ms, t+20 ms]˜P₁[t]×[0.9 1.1 1.2 1.3]). For example, the WTRU may determine one or more quality-based metric(s) based on an expected blockage in the trajectory (e.g., the WTRU may decrease a quality-based metric (e.g., RI) for future instances with estimated blockage, etc.). For example, the WTRU may determine one or more quality-based metric(s) based on a quality-based metric (e.g. RI/CQI) predicted with an Artificial Intelligence Machine Learning (AIML) model (e.g., with inputs comprising one or more of predicted CSI values, measured or predicted SINR, determined estimated interference, WTRU trajectory, estimated blockage, etc.).

The WTRU may report the one or more sets of predicted quality-based metrics (e.g., RI/CQI/SINR) based on the received assistance information. In some examples, the WTRU may determine the accuracy of the NW assistance information based on measuring the accuracy of quality-based metric prediction. In examples, the WTRU may report an indicator of the accuracy of NW assistance information. In some cases, using the NW assistance information, the WTRU may predict and/or report RI/CQI for predicted CSI more accurately, which may improve the end-to-end system throughput performance.

A WTRU may compress and report RI/CQI for multiple predicted CSI. The WTRU may receive a reporting pattern and/or a type of compression from the NW. The WTRU may compress and report RI/CQI for multiple CSI predictions.

The WTRU (e.g., capable of multiple CSI predictions) may receive a configuration on RI/CQI prediction. The configuration may comprise a reporting pattern for RI/CQI (e.g., and/or PMI) (e.g., indicating the time instances, type of CQI table (e.g., and/or PMI codebook type) per prediction instance). The configuration may comprise a type of compression method for RI/CQI. For example, the type of compression method for RI/CQI could be indicated by the NW and/or determined and reported by WTRU. The configuration may comprise parameters for compression methods (e.g., thresholds).

The WTRU may compute PMI based on indicated pattern (e.g., Type II for a first instance, Type I for a second instance, etc.). The WTRU may compute RI/CQI for multiple CSI predictions. The WTRU may determine the type of RI/CQI compression method, for example, based on a NW indication and/or based on WTRU measurements (e.g., doppler, WTRU speed, coherence time, estimated blockage, etc.). For example, if the WTRU speed is measured below a threshold, then the WTRU may select type-2. For example, if the WTRU speed is measured above a threshold, the WTRU may select type-3. For example, if the WTRU received blockage indication, the WTRU may select type-4.

The WTRU may compress the RI/CQI based on the configuration. For example, for type-1, the WTRU may compress the RI/CQI for each prediction instance (e.g., one wideband CQI [4 bit]+per sub-band CQI [2 bit] and single RI for all instances in the prediction window(s)). For example, for type-2 (e.g., [If high speed/low coherence time, etc.]), the WTRU may compress the RI/CQI for a first prediction instance (e.g., wideband CQI [4 bit]+per sub-band CQI [2 bit]+RI), and/or for subsequent instances (e.g., differential wideband CQI [2 bit]+differential sub-band CQI [1 bit]+differential RI). For example, for type-3 (e.g., [If low speed/high coherence time, etc.]), the WTRU may compress the RI/CQI for a first prediction instance wideband CQI [4 bit]+per sub-band CQI [2 bit] and single RI for all window(s), and for subsequent instances differential sub-band CQI [1 bit] (e.g., only differential sub-band CQI [1 bit]). For example, for type-4 (e.g., [high risk of blockage/channel change during the reporting]), the WTRU may compress the RI/CQI for each prediction instance (e.g., Full sub-band CQI [5 bit]+RI). For example, for type-5 (e.g., [indicated reporting pattern]), the WTRU may compress the RI/CQI for each prediction instance (e.g., the WTRU follows the indicated pattern [report/not report] and compression type [e.g., one of the above types]).

The WTRU may report the determined compressed RI/CQI based on the compression type. The WTRU may report the determined compression type for RI/CQI and/or PMI based on the pattern.

1. A method implemented by a wireless transmit receive unit (WTRU), the method comprising:
receiving, from a network, configuration information and network assistance information for CSI prediction;
determining historical channel measurements based on a plurality of measurement resources;
determining a CSI prediction value for a future CSI prediction instance based on the historical channel measurements;
determining a quality-based metric for the future CSI prediction instance based on the historical channel measurements and the network assistance information; and
sending an indication of the quality-based metric for the future CSI prediction instance to the network.

2. The method of claim 1, wherein the network assistance information comprises one or more of: a time instance of a historical reference Interference Measurement Resource (IMR) set, a coefficient for interference scaling relative to the historical reference IMR set, or an indication of a future expected blockage; and
wherein the indication of the future expected blockage comprises one or more of: blockage information embedded into the coefficient for interference scaling, a condition used to determine blockage information, or an indication of a likelihood of a blockage at a future instance.

3. The method of claim 1, further comprising:
determining quality-based metrics based on Interference Measurement Resources (IMRs) and CSI measurements based on channel measurement resources, wherein the historical channel measurements comprise the quality-based metrics and the CSI measurements.

4. The method of claim 3, wherein the CSI prediction value for the future CSI prediction instance is based on the CSI measurements of the historical channel measurements.

5. The method of claim 4, wherein the quality-based metric for the future CSI prediction instance is based on the quality-based metrics of the historical channel measurements and the network assistance information.

6. The method of claim 3, wherein the configuration information comprises an indication of the channel measurement resources for determining the CSI measurements and an indication of a type of the assistance information.

7. The method of claim 1, wherein the quality-based prediction metric for the future CSI prediction instance comprises one or more of a rank indication (RI), a channel quality indicator (CQI) or a Signal-to-Interference-plus-Noise Ratio (SINR) for the future CSI prediction instance.

8. The method of claim 1, wherein the network assistance information comprises one or more time instances of historical reference IMRs and one or more coefficients for interference scaling relative to a historical reference IMR; and
wherein determining the quality-based metric for the future CSI prediction instance comprises determining an estimated interference value for the future CSI prediction instance based on the coefficient for interference scaling and the historical reference IMR.

9. The method of claim 1, wherein the network assistance information comprises an indication of future expected blockages; and
wherein determining the quality-based metric for the future CSI prediction instance comprises determining a decreased Rank Indicator (RI) quality-based metric based on the indication of future expected blockages.

10. The method of claim 1, wherein determining the quality-based metric for the future CSI prediction instance comprises predicting a Rank Indicator (RI) quality-based metric or a Channel Quality Information (CQI) quality-based metric for the future CSI prediction instance based on Artificial Intelligence Machine Learning (AIML) model; and
wherein the AIML model has inputs comprising one or more of: the CSI prediction value, a Signal-to-Interference-plus-Noise Ratio (SINR), an estimated interference, a WTRU trajectory, or an indication of future expected estimated blockages.

11. A wireless transmit receive unit (WTRU), comprising:
a processor configured to:
receive, from a network, configuration information and network assistance information for CSI prediction;
determine historical channel measurements based on a plurality of measurement resources;
determine a CSI prediction value for a future CSI prediction instance based on the historical channel measurements;
determine a quality-based metric for the future CSI prediction instance based on the historical channel measurements and the network assistance information; and
send an indication of the quality-based metric for the future CSI prediction instance to the network.

12. The WTRU of claim 11, wherein the network assistance information comprises one or more of: a time instance of a historical reference Interference Measurement Resource (IMR) set, a coefficient for interference scaling relative to the historical reference IMR set, or an indication of a future expected blockage; and
wherein the indication of the future expected blockage comprises one or more of: blockage information embedded into the coefficient for interference scaling, a condition used to determine blockage information, or an indication of a likelihood of a blockage at a future instance.

13. The WTRU of claim 11, wherein the processor is configured to:
determine quality-based metrics based on Interference Measurement Resources (IMRs) and CSI measurements based on channel measurement resources, wherein the historical channel measurements comprise the quality-based metrics and the CSI measurements.

14. The WTRU of claim 13, wherein the CSI prediction value for the future CSI prediction instance is based on the CSI measurements of the historical channel measurements.

15. The WTRU of claim 14, wherein the quality-based metric for the future CSI prediction instance is based on the quality-based metrics of the historical channel measurements and the network assistance information.

16. The WTRU of claim 13, wherein the configuration information comprises an indication of the channel measurement resources for determining the CSI measurements and an indication of the IMRs for determining the quality-based metrics.

17. The WTRU of claim 11, wherein the quality-based prediction metric for the future CSI prediction instance comprises one or more of a rank indication (RI), a channel quality indicator (CQI) or a Signal-to-Interference-plus-Noise Ratio (SINR) for the future CSI prediction instance.

18. The WTRU of claim 11, wherein the network assistance information comprises one or more time instances of historical reference IMRs and one or more coefficients for interference scaling relative to a historical reference IMR; and
wherein the quality-based metric for the future CSI prediction instance comprises an estimated interference value for the future CSI prediction instance that is determined based on the coefficient for interference scaling and the historical reference IMR.

19. The WTRU of claim 11, wherein the network assistance information comprises an indication of future expected blockages; and
wherein the quality-based metric for the future CSI prediction instance comprises a decreased Rank Indicator (RI) quality-based metric that is determined based on the indication of future expected blockages.

20. The WTRU of claim 11, wherein the processor is configured to:
determine the quality-based metric for the future CSI prediction instance based on a Rank Indicator (RI) quality-based metric or a Channel Quality Information (CQI) quality-based metric using an Artificial Intelligence Machine Learning (AIML) model, wherein the AIML model has inputs comprising one or more of: the CSI prediction value, a Signal-to-Interference-plus-Noise Ratio (SINR), an estimated interference, a WTRU trajectory, or an indication of future expected estimated blockages.
